(19) United States
(12) Patent Application Publication
(10) Pub. No.: US 2023/0321859 A1
(43) Pub. Date: Oct. 12, 2023

(54) KNIFE HOLDER WITH EMBEDDED BLADE CHANGING APPARATUS

(71) Applicant: LEICA BIOSYSTEMS NUSSLOCH GMBH, Nussloch (DE)

(72) Inventors: Jue CHEN, Shanghai (CN); Zheguang FAN, Shanghai (CN); Hongjian TAO, Shanghai (CN)

(21) Appl. No.: 18/022,801

(22) PCT Filed: Sep. 10, 2020
(86) PCT No.: PCT/CN2020/114464

§ 371 Date: Feb. 23, 2023

(51) Int. Cl. B26D 7/26; G01N 1/06

(52) U.S. Cl. CPC B26D 7/2614; G01N 1/06; G01N 2001/061

(57) ABSTRACT

A knife holder is provided. The knife holder includes: a base; a pressure plate pivotally arranged to the base and configured to releasably clamp a blade in a sectioning position together with the base; and a blade changing apparatus embedded in the base and configured to output an unused blade out of the base to change a used blade.

### CROSS-REFERENCE TO RELATED APPLICATION

The present application is a national phase entry under 35 USC § 371 of International Application PCT/CN2020/114464, filed Sep. 10, 2020, the entire disclosure of which is incorporated herein by reference.

### FIELD

Embodiments of the present disclosure generally relate to a microtechnic filed, more particularly, to a knife holder with an embedded blade changing apparatus.

### BACKGROUND

In the related art, a blade changing system usually is attached to a knife holder. For example, the blade changing system may be arranged outside the knife holder and adjacent to one or two sides of the knife holder.

In US8,187,157B2, a microtome blade changing apparatus includes a blade dispenser storing unused blades and a blade container for receiving used blades. The blade dispenser and the blade container are respectively arranged adjacent to the knife holder. An unused blade is transferable with an entraining element from the blade dispenser to the knife holder, and a used blade is thereby conveyable into the blade container.

In US9,304,064B2, the blade changing apparatus includes a driver mechanism next to a knife block. The driver mechanism includes a first driver for a new blade as well as a second driver for an old blade. The first driver and the second driver are coupled to a driving mechanism, on which a driver actuation element acts. By means of the drivers, the new blade is conveyed to the right into a first receptacle, and the old blade is conveyed to the left out of a second receptacle.

In both US8,187,157B2 and US9,304,064B2, the blade changing system is arranged to at least one side of the knife holder, such that the space on such side of the knife holder is occupied, thus influencing the user’s usability of a microtome having the knife holder.

Moreover, in the above prior blade changing systems, the users must be careful in the process of changing the blades because they have the risk of cutting their fingers by the blades. The users also must adjust the new blades to a suitable position after uploading them on the knife holder. Thus, the above prior blade changing systems are not only inefficient but also unsafe.

### SUMMARY

Embodiments of the present disclosure seek to solve at least one of the problems existing in the prior art to at least some extent, and thus provide a knife holder having an embedded blade changing system.

According to embodiments of the present disclosure, there is provided a knife holder. The knife holder includes: a base; a pressure plate pivotally arranged to the base and configured to releasably clamp a blade in a sectioning position together with the base; and a blade changing apparatus embedded in the base and configured to output an unused blade out of the base to change a used blade.

In the knife holder according to embodiments of the present disclosure, the blade changing apparatus is embedded in the base such that the space on both sides of the knife holder will not occupied, thus facilitating a small longitudinal size of the knife holder and also the user’s usability of a microtome having the knife holder. Moreover, it is convenient and safe for the user to change the used blade with the embedded blade changing apparatus.

In some embodiments, the base includes a first base part and a second base part having inclined surfaces fitted with each other, the first base part is arranged on the second base part, and the inclined surface of the second base part has an upper rim extending beyond the inclined surface of the first base part. The pressure plate is pivotally arranged to the first base part and configured to releasably clamp the used blade in the sectioning position together with the upper rim of the inclined surface the second base part. The blade changing apparatus is embedded between the first base part and the second base part and configured to output the unused blade to the sectioning position along the inclined surface of the second base part.

In some embodiments, the knife holder further includes a blade unloading apparatus. The blade unloading apparatus includes: a frame pivotally connected to the pressure plate and configured to pivot to be rested on the used blade in the sectioning position; and a spring pin connected to the frame via a spring, operable to move relative to the frame to push the used blade off the sectioning position, and configured to restore under an action of the spring.

In some embodiments, the blade changing apparatus includes: a blade dispenser detachably arranged in a horizontal through hole of the first base part and configured to abut against the inclined surface of the second base part, the blade dispenser having a plurality of unused blades therein; and an actuating member slidably arranged in the second base part and configured to push the unused blade out of the blade dispenser, and further to advance the unused blade to the sectioning position, when sliding towards the upper rim of the inclined surface of the second base part.

In some embodiments, the inclined surface of the second base part defines a recess therein, and one of two opposite side walls of the second base part has a chute communicated with the recess and extending in an inclination direction of the inclined surface of the second base part. The blade changing apparatus further includes two guide members arranged in the recess and adjacent to the two opposite walls of the second base part, respectively. The guide member also extends in the inclination direction of the inclined surface.

In some embodiments, the actuating member includes: a push rod passing through the chute into the recess and slidably arranged on the two guide members; an operable member connected the push rod, arranged outside the second base part and configured to be operated to drive the push rod to slide along the two guide members; and two abutting protrusions connected to the push rod, each abutting protrusion being arranged between the side wall of the second base part and the corresponding guide member adjacent to said side wall, and being configured to abut against the unused blade in the blade dispenser and to push the unused blade out of the blade dispenser.

In some embodiments, the blade changing apparatus further includes a blade oriented plate arranged in the recess and adjacent to the blade dispenser, and the blade oriented plate is configured to receive the unused blade from the blade dispenser thereon. The blade oriented plate is provided with a positioning block on a surface thereof facing the blade dispenser.

In some embodiments, a surface of the blade oriented plate facing the first base part has a portion adjacent to the blade dispenser and deflected in a direction running away from the inclined surface of the first base part.

In some embodiments, the blade dispenser includes: a main body configured to receive the plurality of unused blades therein, and having a bottom configured to abut against the inclined surface of the second base part; a blade-output slot formed in a top surface of the main body and adjacent to the bottom of the main body; a guide groove formed in the bottom of the main body and communicated with the blade-output slot, the guide groove being configured to guide the abutting protrusion to push the unused blade out of the blade dispenser through the blade-output slot; and a positioning groove formed in the bottom of the main body and spaced apart from the guide groove, the positioning groove being configured to receive the positioning block of the blade oriented plate to position the blade dispenser.

In some embodiments, the bottom of the main body is inclined to be fitted with the inclined surface of the second base part, and the plurality of unused blades are arranged in the blade dispenser at a predetermined angle to be parallel with the bottom of the main body.

In some embodiments, the main body has an open top opposite to the bottom, and the main body is provided with a cover detachably connected to the open top.

In some embodiments, the knife holder further includes: a platform arranged at and perpendicular to the upper rim of the inclined surface of the second base part, the used blade or the unused blade in the sectioning position standing on the platform and lying on the upper rim of the inclined surface of the second base part; a first magnet arranged to the upper rim of the inclined surface of the second base part and configured to attract the used blade or the unused blade to the upper rim of the inclined surface of the second base part; and a second magnet arranged to the platform and configured to attract the used blade or the unused blade to the platform.

In some embodiments, the platform is configured as step between the upper rim of the inclined surface of the second base part and the portion of the inclined surface of the second base part adjacent to the blade oriented plate.

In some embodiments, the knife holder further includes a door arranged at the through hole of the first base part and configured to close the through hole of the first base part to fix the blade dispenser in the first base part.

In some embodiments, the door has a groove in a surface thereof facing the blade disperser. The door includes: a spring received in the groove and connected to a bottom of the groove; and a contact member arranged in the groove, connected to the spring and having a free end extending out of the groove. The contact member is configured to press the blade dispenser against the inclined surface of the second base part.

In some embodiments, the knife holder further includes a locking rod passing through the first base part, the locking rod is operable to push against the pressure plate to cause the pressure plate to press against the used blade or the unused blade to thereby immobilize the used blade or the unused blade in the sectioning position.

In some embodiments, the pressure plate is pivotally connected to the first base part through an attachment piece, and the locking rod passes through the attachment piece and has an eccentric region coacting with the attachment piece of the pressure plate upon rotation of the locking rod.

In some embodiments, the locking rod is provided with a rotatory lever at a free end thereof, and the rotatory lever is operable to rotate the locking rod.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference the accompanying drawings.

FIG. 1 is a perspective view of a knife holder according to an embodiment of the present disclosure.

FIG. 2 is another perspective view of a knife holder according to an embodiment of the present disclosure.

FIG. 3 is a perspective view of a second base part of a knife holder according to an embodiment of the present disclosure.

FIG. 4 is a sectional view of a knife holder according to an embodiment of the present disclosure.

FIG. 5 is a perspective view of a blade dispenser of a knife holder according to an embodiment of the present disclosure.

FIG. 6 is an exploded view of the blade dispenser in FIG. 5.

FIG. 7 is another sectional view of a knife holder according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, Unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

Terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also, it is to be understood that phraseology and terminology used herein with reference to device or element orientation (such as, for example, terms like “central,” “upper,” “lower,” “front,” “rear,” and the like) are only used to simplify description of the present disclosure, and do not alone indicate or imply that the device or element referred to must have a particular orientation.

In addition, terms such as “first” and “second” are used herein for purposes of description and are not intended to indicate or imply relative importance or significance.

Embodiments of the present disclosure provide a knife holder 100. The knife holder 100 according to embodiments of the present disclosure includes a base 1, a pressure plate 2 and a blade changing apparatus 3. The pressure plate 2 is pivotally arranged to the base 1 and configured to releasably clamp a blade in a sectioning position together with the base 1. The blade changing apparatus 3 is embedded in the base 1 and configured to output an unused blade 4′ out of the base 1 to change a used blade 4.

It may be understood by those skilled in the related art that whether a blade is the used blade 4 or the unused blade 4′ is not determined by the fact whether the blade is clamped in the sectioning position, but just relates to the fact that whether the blade has been used for sectioning, because the unused blade 4′ will also be clamped in the sectioning position in the blade change process.

In the knife holder 100 according to embodiments of the present disclosure, the blade changing apparatus 3 is embedded in the base 1 such that the space on both sides of the knife holder 100 will not occupied, thus facilitating a small longitudinal size of the knife holder 100 and also the user’s usability of a microtome having the knife holder 100. Moreover, it is convenient and safe for the user to change the used blade 4 with the embedded blade changing apparatus 3.

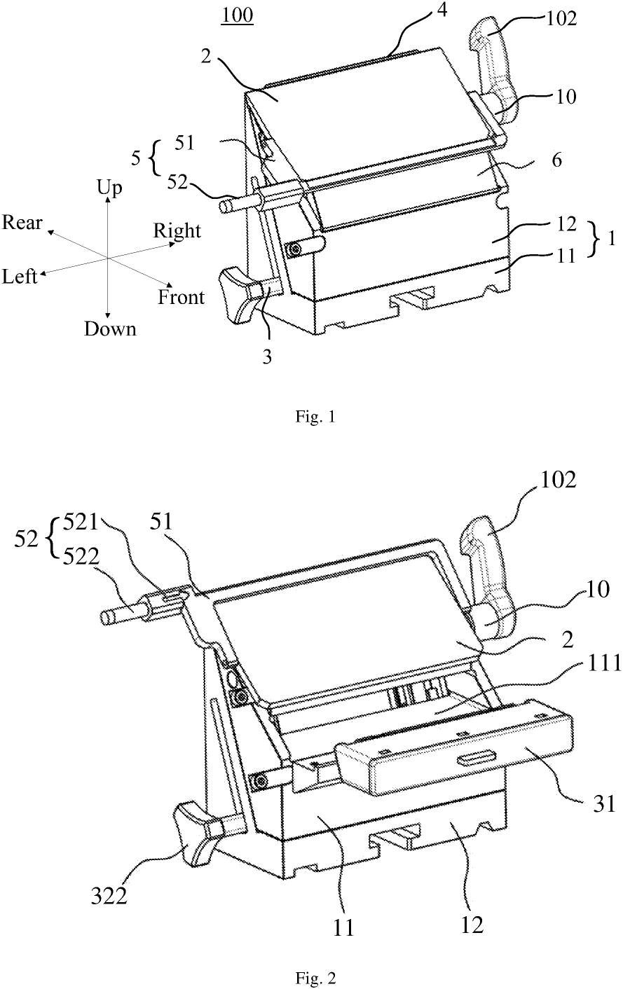

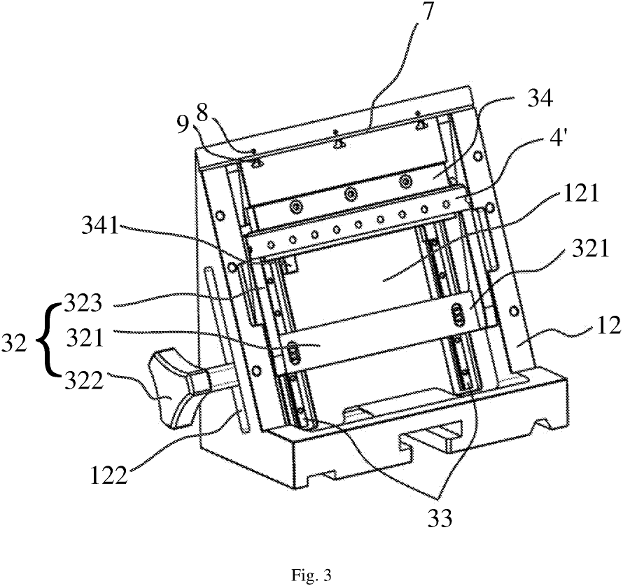

As illustrated in FIGS. 1 and 2, the base 1 includes a first base part 11 and a second base part 12. The first base part 11 is arranged on the second base part 12, and the pressure plate 2 is pivotally arranged to the first base part 11. In other words, the first base part 11 is an upper or front base part, and the second base part 12 is a lower or rear base part. The first base part 11 and the second base part 12 have inclined surfaces fitted with each other. That is, the first base part 11 has an inclined surface, the second base part has another inclined surface, and the inclined surface of the first base part 11 is fitted with the inclined surface of the second base part 12.

Further, the inclined surface of the second base part 12 has an upper rim extending beyond the inclined surface of the first base part 11. In this case, the pressure plate 2 is configured to releasably clamp the used blade 4 in the sectioning position together with the upper rim of the inclined surface the second base part 12. The blade changing apparatus 3 is embedded between the first base part 11 and the second base part 12 and configured to output the unused blade 4′ to the sectioning position along the inclined surface of the second base part 12.

In the embodiments illustrated in FIGS. 1 and 2, the inclined surface of the first base part 11 starts from a top edge of the first base part 11 and terminates at a distance away from a front surface of the first base part 11, and the inclined surface of the second base part 12 also starts from a top edge of the second base part 12 and terminates at a distance from a front surface of the second base part 12, such that the first base part 11 can be stably arranged on the second base part 12.

In some other embodiments, the inclined surface of the first base part 11 may extend to the front surface of the first base part 11, and the inclined surface of the second base part 12 may also extend to the front surface of the second base part 12. In this case, additional connection means may be needed to connect the first base part 11 to the second base part 12.

As further illustrated in FIGS. 1, 2, 4 and 5, the knife holder 100 further includes a blade unloading apparatus 5. The blade unloading apparatus 5 includes a frame 51 and a spring pin 52. The frame 51 is pivotally connected to the pressure plate 2 and configured to pivot to be rested on the used blade 4 in the sectioning position. The spring pin 52 is connected to the frame 51 via a spring, operable to move relative to the frame 51 to push the used blade 4 off the sectioning position, and configured to restore under an action of the spring.

The frame 51 has a half-rectangle shape and thus defines an open end. The open end of the frame 51 is connected to left and right sides of the pressure plate 2 via pivots. The open end of the frame 51 is substantially located in a transverse (horizontal) center line of the pressure plate 2, and a size of the frame 51 from the open end to an opposite end is substantially half of a longitudinal size of the pressure plate 2, such that when the frame 51 pivots upwards around the transverse center line of the pressure plate 2 by an maximum angle, the opposite end of the frame 51 will be rested on the used blade 4 as illustrated in FIG. 2, because at least part (for example, a cutting edge) of the used blade 4 in the sectioning position protrudes beyond the pressure plate 2 and the upper rim of the second base part 12 for sectioning.

In this case, the spring pin 52 may be pushed by a user towards the used blade 4 in the sectioning position so as to force the used blade 4 off the sectioning position. Specifically, the users presses the spring pin 52 to push the at least part of the used blade 4 protruding beyond the pressure plate 2 and the upper rim of the second base part 12, such that the used blade 4 will be at least partially moved out of the knife holder 100. Then, the used blade 4 can be removed by any known tools or manually, which is not limited herein.

After the used blade 4 is removed, the frame 51 will be rotated downwards to be rested on a lower edge of the pressure plate 2.

In other embodiments, when the frame 51 pivots upwards by the maximum angle, the opposite end of the frame 51 may be rested on an upper edge of the pressure plate 2, instead of the used blade 4, and the spring pin 52 may also be arranged in a proper position to be operable to push the used blade 4 out of the knife holder 100.

In some embodiments, the spring pin 52 may include a casing 521 connected to the left side of the frame 51, a pin 522 passing through the casing 521 along a transverse direction of the pressure plate 2, and a spring (not illustrated) received in the casing 521 and fitted over the pin 522. When the pin 522 is moved by an external force towards the used blade 4 in the sectioning position, the spring is compressed, and when the external force is removed, the pin restores under an action of the spring.

For example, the pin 522 is provided with a stopper on its circumferential surface, such that the stopper will compress the spring when the pin 522 moves towards the used blade 4.

When the frame 51 is rested on the used blade 4 in the sectioning position, that is, the used blade 4 is arranged below the frame 51, a horizontal center line of the pin 522 is also below the frame 51 and substantially consistent with a horizontal center line of the used blade 4, such that the pin 522 can push the used blade 4 off the sectioning position stably and reliably.

With the blade unloading apparatus 5 according to embodiments of the present disclosure, it is convenient and easy for the user to unload the used blade 4, thus facilitating the blade change.

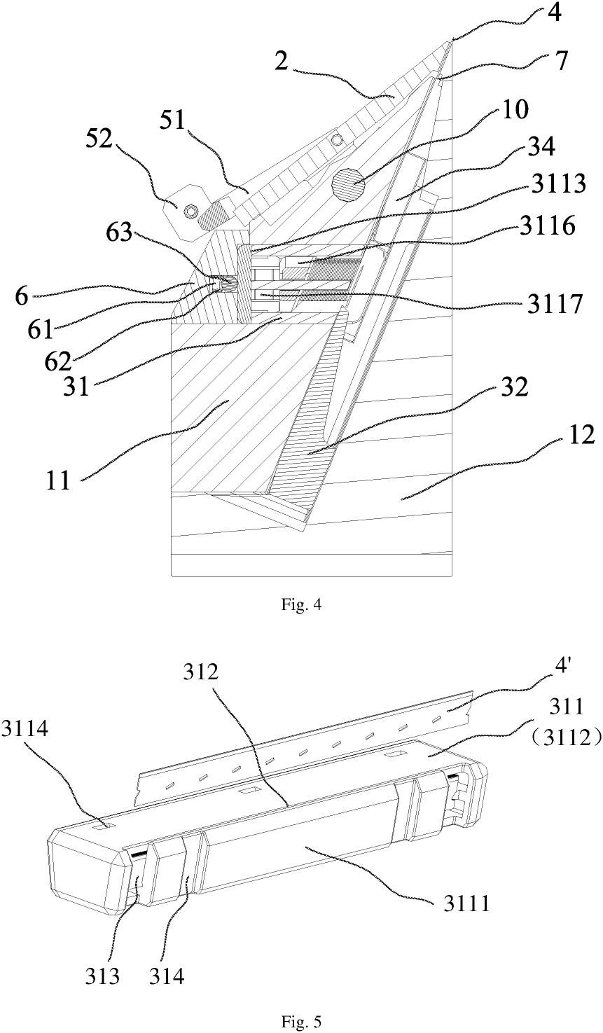

As illustrated in FIGS. 3 and 4, the blade changing apparatus 3 includes a blade dispenser 31 and an actuating member 32. The blade dispenser 31 is detachably arranged in a horizontal through hole 111 of the first base part 11 and is configured to abut against the inclined surface of the second base part 12. The blade dispenser 31 has a plurality of unused blades 4′ therein. The blade dispenser 31 is consumable. That is, when the unused blades 4′ in the blade dispenser 31 are used out, the blade dispenser 31 can be detached from the first base part 11, then filled with other unused blades 4′, and finally inserted into the first base plate 11 again. Or, a new blade dispenser 31 full of unused blades 4′ may replace the blade dispenser 31 whose unused blades 4′ are used out.

The actuating member 32 is slidably arranged in the second base part 12 and configured to push the unused blade 4′ out of the blade dispenser 31, and further to advance the unused blade 4′ to the sectioning position, when sliding towards the upper rim of the inclined surface of the second base part 12.

The knife holder 100 further includes a door 6 arranged at the through hole 111 of the first base part 11 and configured to close the through hole 111 of the first base part 11 to fix the blade dispenser 31 in the first base part 11. In some embodiments, the door 6 may be connected to the first base part 11 via a pivot and can rotate around the pivot to close or open the through hole 111 of the first base part 11, such that the blade dispenser 31 can be removed out of or inserted into the through hole 111 of the first base part 11.

As further illustrated in FIG. 4, the door 6 has a groove 61 in a surface thereof facing the blade disperser 31, and includes a spring 62 and a contact member 63 received in the groove 61. The spring 62 is connected to a bottom of the groove 61. The contact member 63 is connected to the spring 62 and configured to press the blade dispenser 31 against the inclined surface of the second base part 12.

For example, a free end of the contact member 63 protrudes out of the groove 61 such that after the blade dispenser 31 is inserted in the first base part 11 and abuts against the inclined surface of the second base part 12, the contact member 63 can contact and press the blade dispenser 31 against the inclined surface of the second base part 12 under the action of the spring 61 when the door 6 is closed.

In some embodiments, the contact member 63 may be a ball screw, while other proper contact members may also be used, which is not limited herein.

As illustrated in FIG. 3, the inclined surface of the second base part 12 defines a recess 121 therein, and one of two opposite side walls of the second base part 12 defines a chute 122 communicated with the recess 121 and extending in an inclination direction of the inclined surface of the second base part 12. Specifically, the chute 122 is formed in the left side wall of the second base part 12.

The blade changing apparatus 3 further includes two guide members 33 arranged in the recess 121 and adjacent to the two opposite walls of the second base part 12, respectively. As illustrated in FIG. 3, one guide member 33 is arranged in the recess 121 and adjacent to the left side wall of the second base part 12, and the other guide member 33 is arranged in the recess 121 and adjacent to the right side wall of the second base part 12. In some embodiments, the guide member 33 may be a guide rail.

The guide member 33 also extends in the inclination direction of the inclined surface of the second base part 12.

As further illustrated in FIG. 3, the actuating member 32 includes a push rod 321, an operable member 322 and two abutting protrusions 323. The push rod 321 passes through the chute 122 into the recess 121 and slidably arranged on the two guide members 33. The operable member 322 is connected the push rod 321, arranged outside the second base part 12 and configured to be operated to drive the push rod 321 to slide along the two guide members 33. The two abutting protrusions 323 are connected to the push rod 321. Each abutting protrusion 323 is arranged between the side wall of the second base part 12 and the corresponding guide member 33 adjacent to said side wall, and is configured to abut against the unused blade 4′ in the blade dispenser 31 and to push the unused blade 4′ out of the blade dispenser 31.

For example, one abutting protrusion 323 is arranged between the left side wall of the second base part 12 and the corresponding guide member 33 adjacent to the left side wall, and the other abutting protrusion 323 is arranged between the right side wall of the second base part 12 and the corresponding guide member 33 adjacent to the right side wall.

The user may push the operable member 322 upwards to drive the push rod 321 and also the abutting protrusion 323 to move upwards, i.e. along the inclination direction of the inclined surface of the second base part 12, so as to push the unused blade 4′ out of the blade dispenser 31.

When the operable member 322 is moved to a top of the chute 122, the unused blade 4′ is pushed to the sectioning position by the abutting protrusion 323.

When the operable member 322 is located at a bottom of the chute 122, the abutting protrusion 323 is arranged in an original position, i.e. being located below and adjacent to the blade dispenser 31.

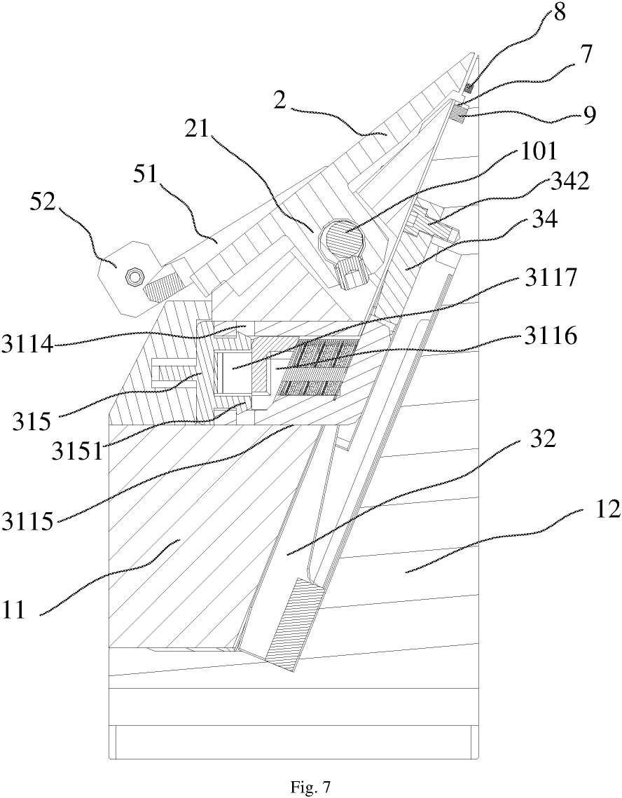

As illustrated in FIGS. 3 and 4, the blade changing apparatus 3 further includes a blade oriented plate 34 arranged in the recess 121 and adjacent to the blade dispenser 31, and the blade oriented plate 34 is configured to receive the unused blade 4′ from the blade dispenser 31 thereon. In some embodiments, the blade oriented plate 34 may be fixed in the recess 121 by screws 342, as illustrated in FIG. 7.

As illustrated in FIG. 4, a surface of the blade oriented plate 34 facing the first base part 11 includes a first portion adjacent to the blade dispenser 31, and a second portion adjacent to a portion of the inclined surface of the second base part 12.

It should be noted that said portion of the inclined surface of the second base part 12 is arranged above the recess 121 in the inclination direction of the inclined surface of the second base part 12.

The first portion of the surface of the blade oriented plate 34 is located at a lower level than the unused blade 4′ to be pushed out of the blade dispenser 31 in a direction perpendicular to the inclined surface of the second base part 12. The second portion of the surface of the blade oriented plate 34 is flush with the portion of the inclined surface of the second base part 12 in the direction perpendicular to the inclined surface of the second base part 12.

That is, the first portion of the surface of the blade oriented plate 34 is deflected in a direction running away from the inclined surface of the first base part 11.

As further illustrated in FIG. 3, the blade oriented plate 34 is provided with a positioning block 341 on its surface facing the blade dispenser 31. The positioning block 341 is used for positioning the blade dispenser 31 when the blade dispenser 31 is inserted in the first base part 11, as described in details below.

As illustrated in FIG. 5, the blade dispenser 31 includes a main body 311, a blade-output slot 312, a guide groove 313 and a positioning groove 314. The main body 311 is configured to receive the plurality of unused blades 4′ therein. The main body 311 has a bottom 3111 configured to abut against the inclined surface of the second base part 12. The blade-output slot 312 is formed in a top surface 3112 of the main body 311 and adjacent to the bottom 3111 of the main body 311. The blade-output slot 312 is preferably aligned with one unused blade 4′ to be pushed out. The guide groove 313 is formed in the bottom 3111 of the main body 311 and communicated with the blade-output slot 311. The guide groove 313 is configured to guide the abutting protrusion 323 to push the unused blade 4′ out of the blade dispenser 31 through the blade-output slot 311. That is, the abutting protrusion 323 can push the unused blade 4′ out of the blade dispenser 31 through the blade-output slot 311 while passing through the guide groove 313. Since two abutting protrusions 323 are provided, two guide grooves 313 should also be provided accordingly, such that the unused blade 4′ can be pushed out of the blade dispenser 31 stably. The positioning groove 314 is formed in the bottom 3111 and spaced apart from the guide groove 313. The positioning groove 314 is configured to receive the positioning block 341 of the blade oriented plate 34 to position the blade dispenser 31. That is, when the blade dispenser 31 is inserted in the first base part 11, the positioning block 341 of the blade oriented plate 34 is received in the positioning groove 314 so as to position the blade dispenser 31.

It may be understood that the blade oriented plate 34 and the portion of the inclined surface of the second base part 12 adjacent to the blade oriented plate 34 should also have guide grooves corresponding to the guide grooves 313 or have a size equal to a size of a portion of the blade dispenser 31 between the two guide grooves 313, such that the abutting protrusions 323 can push the unused blade 4′ to the sectioning position after passing by the blade dispenser 31, the blade oriented plate 34 and the portion of the inclined surface of the second base part 12 adjacent to the blade oriented plate 34.

The bottom 3111 of the main body 311 is inclined to be fitted with the inclined surface of the second base part 12, i.e. parallel to the inclined surface of the second base part 12, such that the bottom 3111 will closely abut against the inclined surface of the second base part 12.

Further, the plurality of unused blades 4′ are arranged in the blade dispenser 31 at a predetermined angle to be parallel with the bottom 3111, i.e. parallel to the inclined surface of the second base part 12, such that the abutting protrusions 323 can push the unused blade 4′ out of the blade dispenser 31 through the blade-output slot 311 smoothly and stably, because the abutting protrusions 323 moves along the chute 122 extending in the inclination direction of the inclined surface of the second base part 12.

Moreover, the unused blade 4′ is positioned with its cutting edge facing upwards, such that the unused blade 4′ will be ready for sectioning once advanced to the sectioning position.

For example, as illustrated in FIGS. 4, 6 and 7, the blade dispenser 31 further includes a push block 3116 arranged in the main body 311. The push block 3116 is slidably fitted in the main body 311, and configured to push the unused blades 4′ against the bottom 3111. Each time one unused blade 4′ is removed out of the blade dispenser 31, the push block 3116 slides towards the bottom 3111 of the main body 311. A surface of the push block 3116 in contact with the unused blades 4′ is also parallel with the inclined surface of the second base part 12. Specifically, a section of the push block 3116 may have a shape of a right trapezoid which is inversed and whose hypotenuse is parallel to the inclined surface of the second base part 12 and in contact with the unused blades 4′.

Moreover, the push block 3116 keeps applying a force on the unused blades 4′ to press the unused blades 4′ against the bottom 3111 of the main body 311, such that when one unused blade 4′ aligned with the blade-output slot 312 is pushed out of the blade dispenser 31, another unused blade 4′ adjacent to the unused blade 4′ pushed out of the blade dispenser 4 can be pushed by the push block 3116 to the bottom 3111.

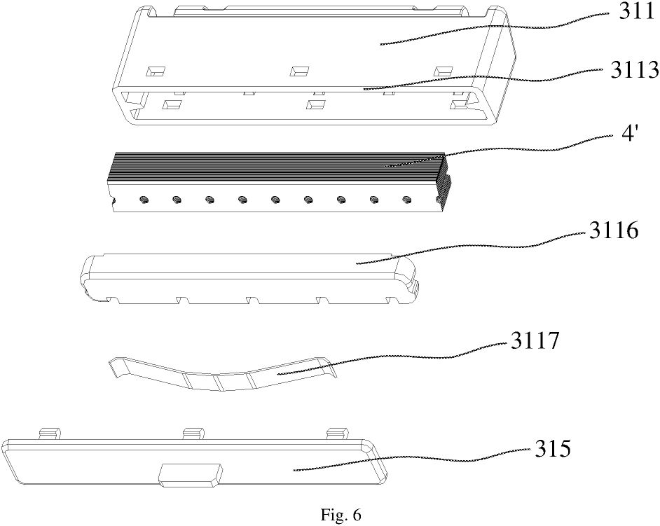

As illustrated in FIGS. 4 and 6, the main body 311 has an open top 3113 opposite to the bottom 3111, and the main body 311 is provided with a cover 315 detachably connected to the open top 3113. The cover 315 may be connected to the main body 311 through a snap fit.

Specifically, the cover 315 is provided with a hook 3151 configured to insert into the main body 311, and the main body 311 is further provided with a hole 3114 in the top surface 3112 and/or a bottom surface 3115 thereof. The hook 3151 is configured to snap into the hole 3114 so as to connect the cover 315 to the main body 311.

Moreover, the blade dispenser 31 further includes an elastic member 3117 arranged in the main body 311 and sandwiched between the cover 315 and the push block 3116. The elastic member 3117 is configured to keep exerting a force on the push block 3116 to press the unused blades 4′ against the bottom 3111 of the main body 311. For example, the elastic member 3117 may be an elastic sheet having an arc shape. The elastic member 3117 is pre-compressed when mounted in the main body 311, and holds in a compressed state at least until all the unused blades 4′ in the blade dispenser 31 are used out.

It may be understood that the elastic member 3117 may have a proper size such that it will not have an interference with the hook 3151.

The cover 315 may be removed from the main body 311, and thus the unused blades 4′ may be placed into or taken out of the main body 311 through the open top 3113.

Further, when the blade dispenser 31 is inserted in the first base part 11 and the door 6 is closed, the contact member 63 abuts against the cover 315 so as to press the blade dispenser 31 against the inclined surface of the second base part 12, and thus the blade dispenser 31 can be arranged in the first base part 11 and supported on the inclined surface of the second baser part 12 stably and firmly.

As further illustrated in FIGS. 3, 4 and 7, the knife holder 100 further includes a platform 7 arranged at and perpendicular to the upper rim of the inclined surface of the second base part 12, the used blade 4 or the unused blade 4′ in the sectioning position stands on the platform 7 and lies on the upper rim of the second base part 12. The knife holder 100 further includes a first magnet 8 arranged to the upper rim of the second base part 12 and configured to attract the used blade 4 or the unused blade 4′ to the upper rim of the second base part 12. The knife holder 100 also includes a second magnet 9 arranged to the platform 7 and configured to attract the used blade 4 or the unused blade 4′ to the platform 7.

In this case, when the unused blade 4′ is pushed to the sectioning position, the unused blade 4′ can be attracted by the first magnet 8 and the second magnet 9 to the upper rim of the inclined surface of the second base part 12 and the platform 7, respectively, that is, two surfaces of the unused blade 4′ are secured to different support surfaces, such that the unused blade 4′ can be immobilized stably in the sectioning position.

In some embodiments, the platform 7 is configured as step between the upper rim of the inclined surface of the second base part 12 and the portion of the inclined surface of the second base part 12 adjacent to the blade oriented plate 34.

As illustrated in FIGS. 1, 2 and 4, the knife holder 100 further includes a locking rod 10 passing through the first base part 11, the locking rod 11 is operable to push against the pressure plate 2 to cause the pressure plate 2 to press against the used blade 4 or the unused blade 4′ to thereby immobilize the used blade 4 or the unused blade 4′ in the sectioning position.

As illustrated in FIG. 7, the pressure plate 2 is pivotally connected to the first base part 11 through an attachment piece 21, and the locking rod 10 passes through the attachment piece 21 and has an eccentric region 101 coacting with the attachment piece 21 of the pressure plate 2 upon rotation of the locking rod 10. In some embodiments, the attachment piece 21 includes a projection.

In some embodiments, the locking rod 10 has a cylindrical shape, and the eccentric region 101 is formed by cutting off a part of a circumference of the locking rod 10 and processing the rest of the circumference of the locking rod 10 into another complete circumference. That is, the eccentric region 101 is an inscribed cylinder of the locking rod 10.

In this case, the eccentric region 101 exhibits a varying (increasing and decreasing) radius in a circumferential direction of the locking rod 10. Different portions of a circumference of the eccentric region 101 come into engagement with the attachment piece 21 of the pressure plate 2 when the locking rod 10 is correspondingly rotated.

When a portion of the circumference of the eccentric region 101 which has an increasing radius in the circumferential direction of the locking rod 10 comes into engagement with the attachment piece 21 of the pressure plate 2, the eccentric region 101 pushes the attachment piece 21 in a direction running away from the inclined surface of the second base part 12. As a result, the pressure plate 2 is pressed with its upper region against the upper rim of the inclined surface of the second base part 12, so that the used blade 4 or the unused blade 4′ can be secured in the sectioning position.

When a portion of the circumference of the eccentric region 101 which has a decreasing radius in the circumferential direction of the locking rod 10 comes into engagement with the attachment piece 21 of the pressure plate 2, the pressure plate 2 is released in an opposite direction, i.e. in a direction facing the inclined surface of the second base part 12, so that the used blade 4 can be pushed out by the spring pin 52 or the unused blade 4′ can be pushed into the sectioning position by the abutting protrusion 323.

As illustrated in FIGS. 1 and 2, the locking rod 10 is provided with a rotatory lever 102 at a free end thereof, and the rotatory lever 102 is operable to rotate the locking rod 10, such that the eccentric region 101 will rotate along with the locking rod 10, thus pressing the pressure plate 2 against the upper rim of the inclined surface of the second base part 12 or releasing the pressure plate 2 from the upper rim of the inclined surface of the second base part 12.

The knife holder 100 according to embodiments of the present disclosure has a following blade changing process.

When the used blade 4 secured in the sectioning position needs to be changed, the user first operates the rotatory lever 102 to rotate the locking rod 10 to thereby release the pressure plate 2 from the upper rim of the inclined surface of the second base part 12. Then, the frame 51 is rotated upwards to be rested on the used blade 4 in the sectioning position, and the user presses the spring pin 52 to push the used blade 4 at least partially out of the knife holder 100. Then, the frame 51 is rotated downwards to be rested on the lower edge of the pressure plate 2, and the user removes the used blade 4 by any tools or manually.

After the used blade 4 is removed, the user pushes the operable member 322 upwards to drive the push rod 321 to slide upwards along the chute 122, such that the abutting protrusion 323 is also driven to move upwards along the guide member 33 to push the unused blade 4′ out of the blade dispenser 31, further onto the blade oriented plate 34 and the portion of the inclined surface of the second base part 12 adjacent to the blade oriented plate 34, and finally into the sectioning position, i.e. standing on the platform 7 and lying on the upper rim of the inclined surface of the second base part 12.

Thereafter, the user operates the rotatory lever 102 again to rotate the locking rod 10 to thereby press the pressure plate 2 against the upper rim of the inclined surface of the second base part 12, so as to secure the unused blade 4′ in the sectioning position.

In the above process, at least a part of the abutting protrusion 323 keeps in contact with the rest unused blades 4′ in the blade dispenser 31, i.e. stopping the rest unused blades 4′, so as to prevent the rest unused blades 4′ form moving to the bottom 3111 of the blade dispenser 31, such that the abutting protrusion 323 can be moved back to its original position without scraping the rest unused blade 4′ in the blade dispenser 31 after pushing the unused blade 4′ to the sectioning position. Then, the rest unused blades 4′ will move to the bottom 3111 of the blade dispenser 31 for next blade change.

In the knife holder 100 according to embodiments of the present disclosure, the blade changing apparatus 3 is embedded in the base 1 such that the space on both sides of the knife holder 100 will not occupied, thus facilitating a small longitudinal size of the knife holder 100 and also the user’s usability of the microtome having the knife holder 100. Moreover, the blade unloading apparatus 5 is provided such that it is convenient and safe to unload the used blade 4. Further, since the embedded blade changing apparatus 3 includes the blade dispenser 31, the actuating member 32, and the blade oriented plate 34 arranged corresponding to and fitted with one another, it is convenient and safe for the user to advance the unused blade 4′ to the sectioning position, thus changing the used blade 4. Additionally, the user does not need to adjust the unused blade 4′ in the sectioning position any more.

Reference throughout this specification to “an embodiment,” “some embodiments,” “one embodiment”, “another example,” “an example,” “a specific examples,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example”, “in an example,” “in a specific examples,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A knife holder (100), comprising:
a base (1);
a pressure plate (2) pivotally arranged to the base (1) and configured to releasably clamp a blade in a sectioning position together with the base (1); and
a blade changing apparatus (3) embedded in the base (1) and configured to output an unused blade (4′) out of the base (1) to change a used blade (4).

2. The knife holder (100) according to claim 1, wherein the base (1) comprises a first base part (11) having an inclined surface and a second base part (12) having an inclined surface fitted with the inclined surface of the first base part (11), the first base part (11) is arranged on the second base part (122), and the inclined surface of the second base part (12) has an upper rim extending beyond the inclined surface of the first base part (11),
the pressure plate (2) is pivotally arranged to the first base part (11) and configured to releasably clamp the used blade (4) in the sectioning position together with the upper rim of the inclined surface the second base part (12), and
the blade changing apparatus (3) is embedded between the first base part (11) and the second base part (12) and configured to output the unused blade (4′) to the sectioning position along the inclined surface of the second base part (12).

3. The knife holder (100) according to claim 2, further comprising a blade unloading apparatus (5), wherein the blade unloading apparatus (5) comprises:
a frame (51) pivotally connected to the pressure plate (2) and configured to pivot to be rested on the used blade (4) in the sectioning position; and
a spring pin (52) connected to the frame (51) by way of a spring, operable to move relative to the frame (51) to push the used blade (4) off the sectioning position, and configured to restore under an action of the spring.

4. The knife holder (100) according to claim 2, wherein the blade changing apparatus (3) comprises:
a blade dispenser (31) detachably arranged in a horizontal through hole (111) of the first base part (11) and configured to abut against the inclined surface of the second base part (12), the blade dispenser (31) configured to have a plurality of unused blades (4′) therein; and
an actuating member (32) slidably arranged in the second base part (12) and configured to push the unused blade (4′) out of the blade dispenser (31), and further to advance the unused blade (4′) to the sectioning position, when sliding towards the upper rim of the inclined surface of the second base part (12).

5. The knife holder (100) according to claim 4, wherein the inclined surface of the second base part (12) defines a recess (121) therein, and one of two opposite side walls of the second base part (12) has a chute (122) communicated with the recess (121) and extending in an inclination direction of the inclined surface of the second base part (12), and
the blade changing apparatus (3) further comprises two guide members (33) arranged in the recess (121) and adjacent to the two opposite walls of the second base part (12), respectively, the two guide members (33) also extending in the inclination direction of the inclined surface of the second base part (12).

6. The knife holder (100) according to claim 5, wherein the actuating member (32) comprises:
a push rod (321) passing through the chute (122) into the recess (121) and slidably arranged on the two guide members (33);
an operable member (322) connected to the push rod (321), arranged outside the second base part (12) and configured to be operated to drive the push rod (321) to slide along the two guide members (33); and
two abutting protrusions (323) connected to the push rod (321), each abutting protrusion (323) being arranged between one of the two side walls of the second base part (12) and the corresponding guide member (33) adjacent to said one side wall, and being configured to abut against the unused blade (4′) in the blade dispenser (31) and to push the unused blade (4′) out of the blade dispenser (31).

7. The knife holder (100) according to claim 6, wherein the blade changing apparatus (3) further comprises a blade oriented plate (34) arranged in the recess (121) and adjacent to the blade dispenser (31), and the blade oriented plate (34) is configured to receive the unused blade (4′) from the blade dispenser (31) thereon, and
the blade oriented plate (34) is provided with a positioning block (341) on a surface thereof facing the blade dispenser (31).

8. The knife holder (100) according to claim 7, wherein a surface of the blade oriented plate (34) facing the first base part (11) has a portion adjacent to the blade dispenser (31) and deflected in a direction extending away from the inclined surface of the first base part (11).

9. The knife holder (100) according to claim 7, wherein the blade dispenser (31) comprises:
a main body (311) configured to receive the plurality of unused blades (4′) therein, and having a bottom (3111) configured to abut against the inclined surface of the second base part (12);
a blade-output slot (312) formed in a top surface (3112) of the main body (311) and adjacent to the bottom (3111) of the main body (311);
a guide groove (313) formed in the bottom (3111) of the main body (311) and communicated with the blade-output slot (312), the guide groove (313) being configured to guide one of the two abutting protrusions (323) to push the unused blade (4′) out of the blade dispenser (31) through the blade-output slot (3121); and
a positioning groove (314) formed in the bottom (3111) of the main body (311) and spaced apart from the guide groove (313), the positioning groove (314) being configured to receive the positioning block (341) of the blade oriented plate (34) to position the blade dispenser (31).

10. The knife holder (100) according to claim 9, wherein the bottom (3111) of the main body (311) is inclined to be fitted with the inclined surface of the second base part (12), and the blade dispenser (31) is configured to arrange the plurality of unused blades (4′) in the blade dispenser (31) at a predetermined angle to be parallel with the bottom (3111) of the main body (311).

11. The knife holder (100) according to claim 9, wherein the main body (311) has an open top (3113) opposite to the bottom (3111), and the main body (311) is provided with a cover (315) detachably connected to the open top (3113).

12. The knife holder (100) according to claim 8, further comprising:
a platform (7) arranged at and perpendicular to the upper rim of the inclined surface of the second base part (12), the used blade (4) or the unused blade (4′) in the sectioning position standing on the platform (7) and lying on the upper rim of the inclined surface of the second base part (12);
a first magnet (8) arranged to the upper rim of the inclined surface of the second base part (12) and configured to attract the used blade (4) or the unused blade (4′) to the upper rim of the inclined surface of the second base part (12); and
a second magnet (9) arranged to the platform (7) and configured to attract the used blade (4) or the unused blade (4′) to the platform (7).

13. The knife holder (100) according to claim 12, wherein the platform (7) is configured as step between the upper rim of the inclined surface of the second base part (12) and a portion of the inclined surface of the second base part (12) adjacent to the blade oriented plate (34).

14. The knife holder (100) according to claim 4, further comprising a door (6) arranged at the through hole (111) of the first base part (11) and configured to close the through hole (111) of the first base part (11) to fix the blade dispenser (31) in the first base part (11).

15. The knife holder (100) according to claim 14, wherein the door (6) has a groove (61) in a surface thereof facing the blade dispenser (31), and comprises:
a spring (62) received in the groove (61) and connected to a bottom of the groove (61); and
a contact member (63) arranged in the groove (61), connected to the spring (62) and having a free end extending out of the groove (61), the contact member (63) being configured to press the blade dispenser (31) against the inclined surface of the second base part (12).

16. The knife holder (100) according to claim 2, further comprising a locking rod (10) passing through the first base part (11), the locking rod (10) is operable to push against the pressure plate (2) to cause the pressure plate (2) to press against the used blade (4) or the unused blade (4′) to thereby immobilize the used blade (4) or the unused blade (4′) in the sectioning position.

17. The knife holder (100) according to claim 16, wherein the pressure plate (2) is pivotally connected to the first base part (11) through an attachment piece (21), and the locking rod (10) passes through the attachment piece (21) and has an eccentric region (101) coacting with the attachment piece (21) of the pressure plate (2) upon rotation of the locking rod (10).

18. The knife holder (100) according to claim 16, wherein the locking rod (10) is provided with a rotatory lever (102) at a free end thereof, and the rotatory lever (102) is operable to rotate the locking rod (10).
